(19) United States
(12) Patent Application Publication
(10) Pub. No.: US 2014/0328233 A1
(43) Pub. Date: Nov. 6, 2014

(54) PORTABLE DEVICE FOR RECEIVING BROADCAST INFORMATION

(71) Applicant: MediaTek Inc., Hsin-Chu (TW)

(72) Inventors: Yi-Shing SHIH, Changhua City (TW); Che-Hung LIAO, Taichung City (TW); Yuan-Hung CHUNG, Zhubei City (TW); Kun-Chien HUNG, Kanding Township (TW); Chin-Wei HUANG, Hsinchu City (TW); Wei-Chen WANG, Kaohsiung City (TW); Tsai-Yuan HSU, Jhubei City (TW); Chao-Wen CHOU, Zhubei City (TW)

(73) Assignee: MediaTek Inc., Hsin-Chu (TW)

(21) Appl. No.: 14/159,218

(22) Filed: Jan. 20, 2014

Related U.S. Application Data
(60) Provisional application No. 61/819,206, filed on May 3, 2013.

(51) Int. Cl. H04W 52/02

(52) U.S. Cl. CPC H04W 52/0229; H04W 52/029
USPC 370/311

(57) ABSTRACT

A portable device for receiving broadcast information is provided. A mixer down-converts a radio-frequency signal with a local oscillation clock to provide an intermediate frequency signal. A filter is arranged to filter the intermediate frequency signal. An analog-to-digital converter converts the filtered intermediate frequency signal into a digital signal according to a sampling rate. The broadcast information is obtained according to the digital signal. The local oscillation clock has a first frequency in a normal mode and a second frequency in a power-saving mode, and the second frequency is lower than the first frequency.

### CROSS REFERENCE TO RELATED APPLICATIONS

This Application claims priority of U.S. Provisional Application No. 61/819,206, filed on May 3, 2013, the entirety of which is incorporated by reference herein.

### BACKGROUND OF THE INVENTION

1. Field of the Invention

The invention relates to a portable device, and more particularly, to a method for controlling power consumption of a portable device when receiving broadcast information.

2. Description of the Related Art

Presently, portable devices (such as a tablet personal computer, a notebook, a cellular phone, and so on) can provide wireless data service via cellular networks (e.g. 3G standard) and wireless local area networks (WLANs) (e.g. IEEE 802.11 series standard). In general, WLAN service is typically cheaper to implement than cellular service due to the use of unlicensed frequency bands by WLANs.

The portable devices connected to a wireless LAN constantly require a stable power supply to operate on a high-speed wireless LAN. However, since the portable devices are typically powered by a compact battery having a limited capacity, it is becoming increasingly important to reduce power consumption in the portable devices.

### BRIEF SUMMARY OF THE INVENTION

Portable devices for receiving broadcast information and methods are provided. An embodiment of a portable device for receiving broadcast information is provided. The portable device comprises: a mixer, down-converting a radio-frequency signal with a local oscillation clock to provide an intermediate frequency signal; a filter, arranged to filter the intermediate frequency signal; and an analog-to-digital converter, converting the filtered intermediate frequency signal into a digital signal according to a sampling rate. The broadcast information is obtained according to the digital signal. The local oscillation clock has a first frequency in a normal mode and a second frequency in a power-saving mode, and the second frequency is lower than the first frequency.

Furthermore, another embodiment of a portable device for receiving broadcast information is provided. The portable device comprises: a mixer, down-converting a radio-frequency signal with a local oscillation clock to provide an intermediate frequency signal; a filter, arranged to filter the intermediate frequency signal; and an analog-to-digital converter, converting the filtered intermediate frequency signal into a digital signal according to a sampling rate. The broadcast information is obtained according to the digital signal. The filter has a first number of order in a normal mode and a second number of order in a power-saving mode, and the second number of order is smaller than the first number of order.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a communication system according to an embodiment of the invention;

FIG. 2 shows a portable device according to an embodiment of the invention;

FIG. 3 shows a schematic illustrating a low-pass filter according to an embodiment of the invention;

FIG. 4 shows a portable device according to another embodiment of the invention; and

FIG. 5 shows a portable device according to another embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

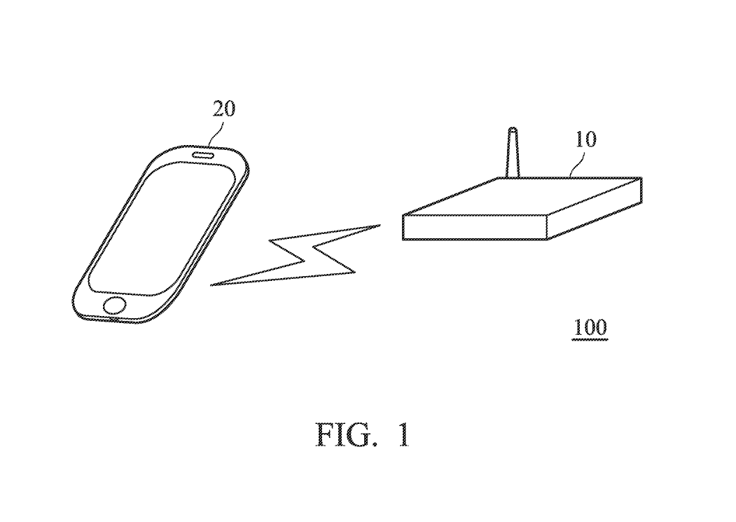

FIG. 1 shows a communication system 100 according to an embodiment of the invention. The communication system 100 comprises a wireless access point (AP) 10 and a portable device 20. By using wireless local area network (WLAN) technology, the portable device 20 communicates data or connects to a network via the wireless access point 10. In general, WLAN standards are defined by the IEEE 802.11. When no data is communicated between the wireless access point 10 and the portable device 20, the portable device 20 will enter a sleeping mode and periodically wake up to receive beacons from the wireless access point 10. Beacon is an information frame sent by the wireless access point 10 periodically. The information frame contains a plurality of Information Elements (IEs) regarding the wireless access point 10. The IEs are essential for the portable device 20 in order to associate and communicate with the wireless access point 10. When receiving the beacons, the portable device 20 will operate in a power-saving mode for decreasing power consumption without foregoing signal-to-noise and distortion ratio (SNDR) or Adjacent Channel Interface (ACI)/Alternate ACI (AACI) requirements. The portable device 20 operating in the power-saving mode listens to beacons periodically broadcast from the wireless access point 10. If the portable device 20 is informed via broadcast information from the beacon that data packets are buffered at the wireless access point 10, the portable device 20 will send a trigger to the wireless access point 10 for the queued data packets. In general, the broadcast information comprises beacon interval (e.g. 102.4 ms), supported rates (e.g. a maximum rate that the wireless access point 10 can support), direct sequence parameter set (e.g. the channel that the wireless access point 10 uses for communication), traffic indication map (TIM) (e.g. the information indicates whether the wireless access point 10 has buffered data for a specific station) and so on.

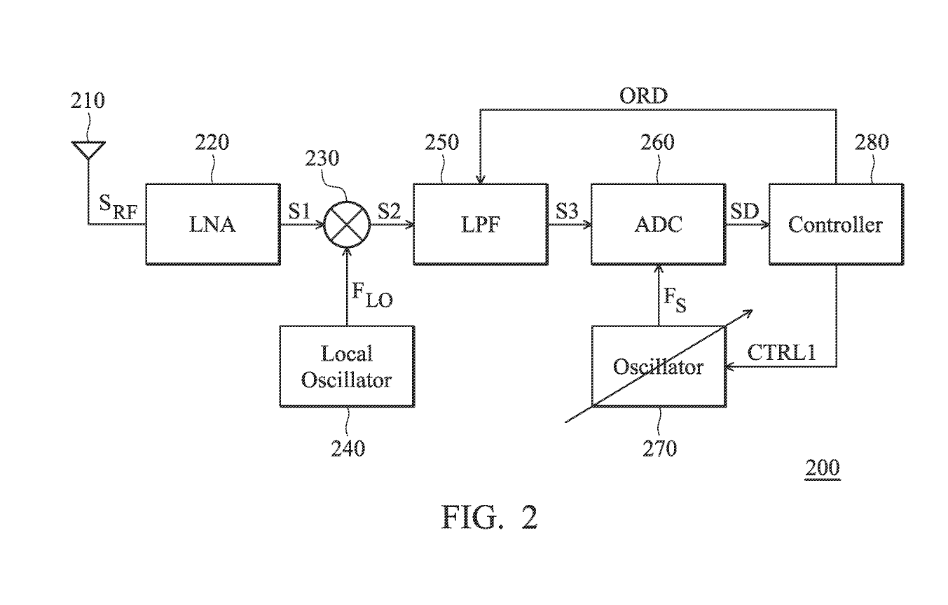

FIG. 2 shows a portable device 200 according to an embodiment of the invention. The portable device 200 comprises an antenna 210, a low-noise amplifier (LNA) 220, a mixer 230, a local oscillator (LO) 240, a filter 250, an analog-to-digital converter (ADC) 260, an oscillator 270 and a controller 280. In the embodiment, the filter 250 is a low-pass filter (LPF). In one embodiment, the filter 250 is a band-pass filter. If a link between the portable device 200 and a wireless access point is normal, the portable device 200 is capable of communicating data with the wireless access point, wherein the portable device 200 operates at 20, 40 or 80 MHz channel bandwidth (CBW20, CBW40 or CBW80). The LNA 220 receives a radio frequency (RF) signal S_{RF} via the antenna 210 and provides a signal S1 according to the RF signal S_{RF}, wherein the radio-frequency signal S_{RF} comprises a beacon from a wireless access point. In the embodiment, the wireless access point only supports 20 MHz channel bandwidth (only CBW20). Therefore, the local oscillator 240 provides a local oscillation clock F_{LO} with a center frequency, to the mixer 230. Next, the mixer 230 down-converts the signal S1 with the local oscillation clock F_{LO} to provide an intermediate frequency (IF) signal S2 according to a bandwidth of 20 MHz. In the embodiments, the IF signal S2 may be a zero-IF signal or a low-IF signal according to various applications. Next, the LPF 250 filters the IF signal S2 to provide a signal S3. In the embodiment, a number of order of the LPF 250 is controlled by a control signal ORD from the controller 280. Next, the ADC 260 converts the signal S3 into a digital signal SD according to a sampling rate F_{S} from the oscillator 270, wherein the sampling rate F_{S} is controlled by a control signal CTRL1 from the controller 280. According to the digital signal SD, the controller 280 can obtain broadcast information via the beacon from the wireless access point. As described above, when no data will be communicated between the wireless access point and the portable device 200, the portable device 200 will enter a sleep mode (e.g., one of the power-saving modes) and periodically wake up to receive beacons from the wireless access point. When waking up, the portable device 200 can operate in two modes: a normal mode and a power-saving mode, to receive the beacons.

In the normal mode utilized in one embodiment, the controller 280 provides the control signal ORD to keep the number of order of the LPF 250, such that the number of order of the LPF 250 in the normal mode is identical to the number of order of the LPF 250 that is used to perform data communication. Furthermore, the controller 280 provides the control signal CTRL1 to the oscillator 270, to keep the sampling rate F_{S} , for example, at 80 MHz, 160 MHz or higher frequency, so as to better avoid aliasing from ACI/AACI. Conversely, in a power-saving mode utilized in the embodiment, the controller 280 provides the control signal ORD to decrease the number of order of the LPF 250, such that the number of order of the LPF 250 in the power-saving mode is smaller than the number of order of the LPF 250 in the normal mode. Thus, a portion of circuits are disabled in the LPF 250 and the power consumption of the portable device 200 is decreased. Furthermore, in another embodiment, the controller 280 may provide the control signal CTRL1 to the oscillator 270, to decrease the sampling rate F_{S} to 80 MHz. Due to the sampling rate F_{S} being decreased, the operating frequency of the ADC 260 is also decreased, and thereby the power consumption is decreased for the portable device 200.

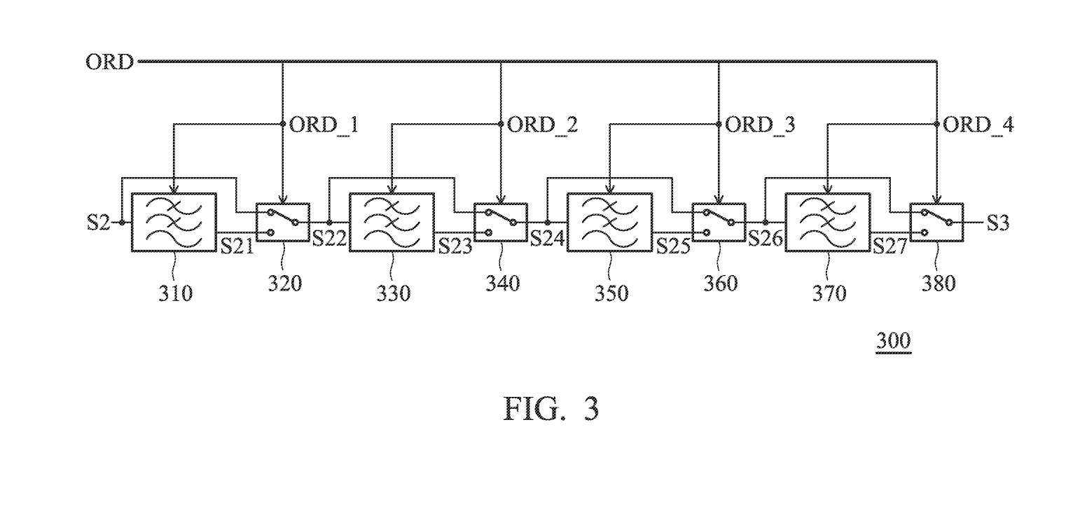

FIG. 3 shows a schematic illustrating a low-pass filter 300 according to an embodiment of the invention. The low-pass filter 300 comprises four sub-filters 310, 330, 350 and 370 and four switches 320, 340, 360 and 380, wherein each sub-filter is a one order filter. In the embodiment, the number of order of the low-pass filter 300 is controlled by a control signal ORD, wherein the control signal ORD comprises the sub-signals ORD_1, ORD_2, ORD_3 and ORD_4. The switch 320 is coupled between the sub-filters 310 and 330, which is used to selectively provide the IF signal S2 or S21 as a signal S22 according to the sub-signal ORD_1, wherein the sub-filter 310 filters the IF signal S2 from a mixer (e.g. 230 of FIG. 2) to generate the signal S21. For example, when the sub-signal ORD_1 is at a first logic level, the switch 320 provides the signal S21 to the sub-filter 330 and the switch 340, serving as the signal S22, i.e. the signal S21 is transmitted from the sub-filter 310 to the sub-filter 330 and the switch 340. When the sub-signal ORD_1 is at a second logic level complementary to the first logic level, the switch 320 provides the IF signal S2 to the sub-filter 330 and the switch 340, serving as the signal S22. Therefore, the IF signal S2 is directly transmitted from the mixer to the sub-filter 330 and the switch 340 without passing through the sub-filter 330, i.e. the sub-filter 310 is bypassed. Furthermore, when the sub-filter 310 is bypassed for the IF signal S2, the sub-filter 310 is disabled by the sub-signal ORD_1 at the same time. Similarly, the switch 340 is coupled between the sub-filters 330 and 350, which is used to selectively provide the signal S22 or S23 as a signal S24 according to the sub-signal ORD_2, wherein the sub-filter 330 filters the signal S22 from the switch 320 to generate the signal S23. The switch 360 is coupled between the sub-filters 350 and 370, which is used to selectively provide the signal S24 or S25 as a signal S26 according to the sub-signal ORD_3, wherein the sub-filter 350 filters the signal S24 from the switch 340 to generate the signal S25. The switch 380 is coupled between the sub-filter 370 and a ADC (e.g. 260 of FIG. 2), which is used to selectively provide the signal S26 or S27 as the signal S3 according to the sub-signal ORD_4, wherein the sub-filter 370 filters the signal S26 from the switch 360 to generate the signal S27. Therefore, in a normal mode, no sub-filter is bypassed, thus the number of order of the low-pass filter 300 is 4 and the low-pass filter has a specific bandwidth. In a power-saving mode, the sub-filter 310, 330, 350 or 370 can be bypassed according to various power saving requirements, and the bandwidth of the low-pass filter 300 is also decreased, such that the bandwidth of the low-pass filter 300 of the power-saving mode is narrower than the specific bandwidth of the normal mode. For example, in the power-saving mode, in order to filter the IF signal S2 from the mixer, the maximum number of order of the low-pass filter 300 is 3 when only one sub-filter is bypassed, and the minimum number of order of the low-pass filter 300 is 1 when three sub-filters are bypassed, wherein the bandwidth corresponding to the maximum number of order is larger than the bandwidth corresponding to the minimum number of order. In one embodiment, in order to further decrease power consumption, all of the sub-filters can be bypassed in the low-pass filter 300, and the IF signal S2 from the mixer will directly be transmitted to the ADC without filtering. It should be noted that the number of sub-filters is used as an example, and not to limit the invention.

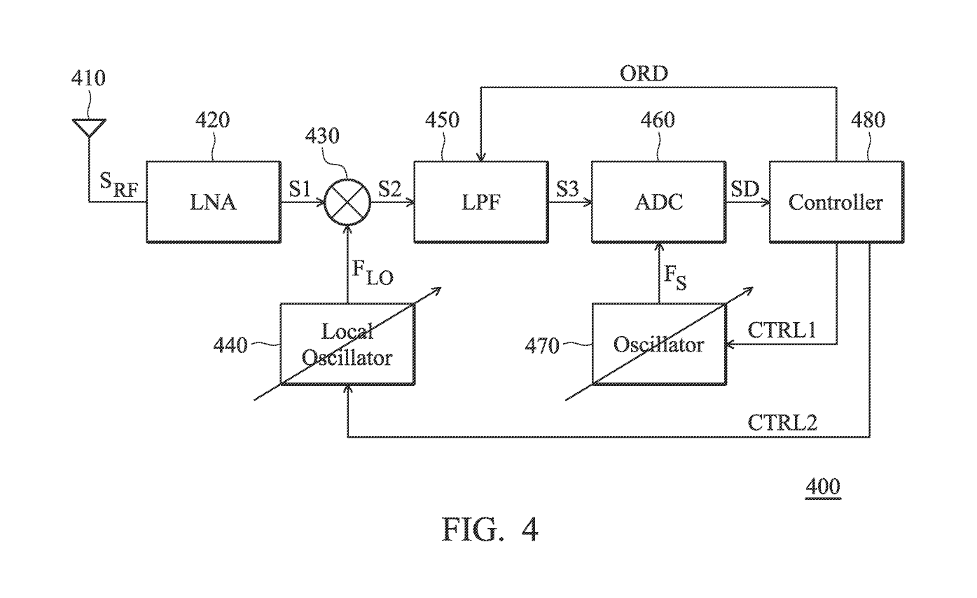

FIG. 4 shows a portable device 400 according to another embodiment of the invention. The portable device 400 comprises an antenna 410, a low-noise amplifier (LNA) 420, a mixer 430, a local oscillator (LO) 440, a low-pass filter (LPF) 450, an analog-to-digital converter (ADC) 460, an oscillator 470 and a controller 480. The portable device 400 is capable of communicating data with the wireless access point. In the embodiment, the link between the portable device 400 and the wireless access point supports 20/40/80 MHz channel bandwidth (CBW20/CBW40/CBW80) for data communication. Compared with the portable device 200 of FIG. 2, the local oscillator 440 provides a local oscillation clock F_{LO} with a variable/adjustable center frequency, to the mixer 430, wherein the variable/adjustable center frequency is controlled by a control signal CTRL2 from the controller 480.

More particularly, if the wireless access point supports 40/80 MHz channel bandwidth for normal data communication and 20 MHz for beacons, the portable device 400 is arranged to adjust the center frequency of local oscillation clock F_{LO} for receiving the beacons. Therefore, in the normal mode for normal data communication, the controller 480 provides the control signal CTRL2 to the local oscillator 440, so as to provide the local oscillation clock F_{LO} with a first center frequency to the mixer 430 for the normal data. In the power-saving mode, the controller 480 provides the control signal CTRL2 to the local oscillator 440, so as to provide the local oscillation clock F_{LO} with a second center frequency different from the first center frequency to the mixer 430 for beacon, thus the frequency of the local oscillation clock F_{LO} is changed. As described above, in the power-saving mode, the controller 480 may provide the control signal CTRL1 to the oscillator 470, to decrease the sampling rate F_{S}, and/or the controller 480 may provide the control signal ORD to decrease the number of order and bandwidth of the LPF 450.

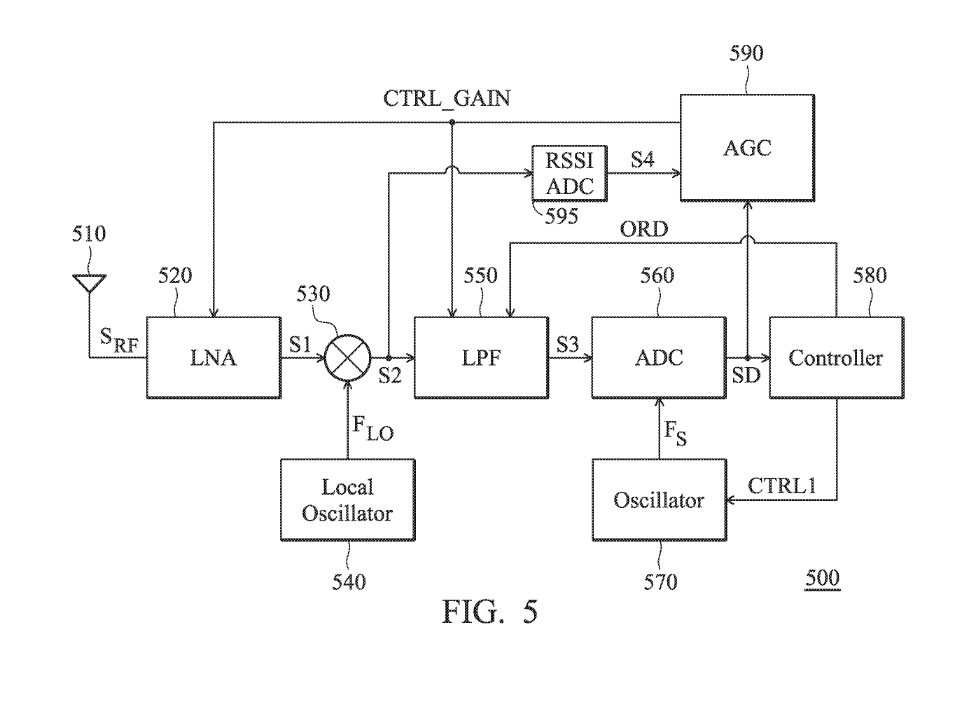

FIG. 5 shows a portable device 500 according to another embodiment of the invention. Compared with the portable device 200 of FIG. 2 and the portable device 400 of FIG. 4, the portable device 500 further comprises an auto gain controller (AGC) 590 and a received signal strength indicator (RSSI) ADC 595. The RSSI ADC 595 obtains a RSSI value according to the signal S2, and the RSSI ADC 595 converts the RSSI value into a digital signal S4 according to a sampling rate (e.g. the sampling rate F_{S} from the oscillator 570). In a normal mode, the AGC 590 provides a control signal CTRL_GAIN to the LNA 520 and the LPF 550 according to the digital signal SD from the ADC 560 and the digital signal S4 from the RSSI ADC 595, so as to control the gains of the LNA 520 and/or the LPF 550. Contrarily, in a power-saving mode, the AGC 590 provides the control signal CTRL GAIN only according to the digital signal SD without the digital signal S4. Thus, the RSSI ADC 595 can be disabled in the power-saving mode, thereby the power consumption is decreased for the portable device 500.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable device for receiving broadcast information, comprising:
a mixer, down-converting a radio-frequency signal with a local oscillation clock to provide an intermediate frequency signal;
a filter, arranged to filter the intermediate frequency signal; and
an analog-to-digital converter, converting the filtered intermediate frequency signal into a digital signal according to a sampling rate,
wherein the broadcast information is obtained according to the digital signal,
wherein the local oscillation clock has a first frequency in a normal mode and a second frequency in a power-saving mode, and the second frequency is different from the first frequency.

2. The portable device as claimed in claim 1, wherein the filter has a first number of order in the normal mode and a second number of order in the power-saving mode, and the second number of order is smaller than the first number of order.

3. The portable device as claimed in claim 1, wherein the filter has a first bandwidth in the normal mode and a second bandwidth in the power-saving mode, and the second bandwidth is narrower than the first bandwidth.

4. The portable device as claimed in claim 1, wherein the sampling rate arranged for the normal mode is higher than the sampling rate arranged for the power-saving mode.

5. The portable device as claimed in claim 1, wherein the radio-frequency signal comprises the broadcast information regarding a beacon from an access point, the filter is a low-pass filter and the intermediate frequency signal is a zero-IF signal.

6. The portable device as claimed in claim 1, wherein the filter is arranged to be bypassed in the power-saving mode, and the analog-to-digital converter converts the intermediate frequency signal into the digital signal according to the sampling rate when the filter is bypassed.

7. A portable device for receiving broadcast information, comprising:
a mixer, down-converting a radio-frequency signal with a local oscillation clock to provide an intermediate frequency signal;
a filter, arranged to filter the intermediate frequency signal; and
an analog-to-digital converter, converting the filtered intermediate frequency signal into a digital signal according to a sampling rate,
wherein the broadcast information is obtained according to the digital signal,
wherein the filter has a first number of order in a normal mode and a second number of order in a power-saving mode, and the second number of order is smaller than the first number of order.

8. The portable device as claimed in claim 7, wherein the sampling rate arranged for the normal mode is higher than the sampling rate arranged for the power-saving mode.

9. The portable device as claimed in claim 7, wherein the local oscillation clock has the same frequency in the normal mode and the power-saving mode.

10. The portable device as claimed in claim 7, wherein the radio-frequency signal comprises the broadcast information regarding a beacon from an access point, the filter is a low-pass filter and the intermediate frequency signal is a zero-IF signal.

11. The portable device as claimed in claim 7, wherein the filter is arranged to be bypassed in the power-saving mode, and the analog-to-digital converter converts the intermediate frequency signal into the digital signal according to the sampling rate when the filter is bypassed.

12. The portable device as claimed in claim 7, wherein the radio-frequency signal comprises the broadcast information regarding a beacon from an access point using a channel bandwidth with a specific value.
